(19) United States
(12) Patent Application Publication
(10) Pub. No.: US 2009/0104330 A1
(43) Pub. Date: Apr. 23, 2009

(54) REDUCED SODIUM SALTY TASTE COMPOSITION, PROCESS FOR ITS PREPARATION AND FOOD SYSTEMS CONTAINING SUCH COMPOSITION

(75) Inventor: Dmitriy V. ZASYPKIN, Cockeysville, MD (US)

Correspondence Address: OBLON, SPIVAK, MCCLELLAND MAIER & NEUSTADT, P.C., 1940 DUKE STREET, ALEXANDRIA, VA, 22314, US

(73) Assignee: MCCORMICK & COMPANY, INC., Sparks, MD (US)

(21) Appl. No.: 11/875,579

(22) Filed: Oct. 19, 2007

(51) Int. Cl. A23L 1/237; A23L 1/22; A23L 1/236

(52) U.S. Cl. 426/534; 426/548; 426/649

(57) ABSTRACT

A reduced sodium salty taste composition for reduction of sodium chloride in food contains sodium chloride, at least one of a food acid and a salt of a food acid, at least one of an amino acids and a salt of an amino acid, and can additionally contain potassium chloride, yeast extract, sweeteners, and flavors. A food containing the reduced sodium salty taste composition and a process for making the reduced sodium salty taste composition are disclosed.

### BACKGROUND OF THE INVENTION

1. Field of the Invention

The present invention relates to a reduced sodium composition imparting salty taste. The invention further relates to food, seasonings, and flavorings that contain the reduced sodium salty taste composition. The invention also relates to a process of flavoring a food by including the reduced sodium salty taste composition of the invention and a process of making the reduced salt composition.

2. Discussion of the Background

Salt in the form of sodium chloride is known to perform multiple functions in foods, including taste enhancement, preservation of foods by suppressing microbial activity, texture modification, masking off-notes, as well as many other uses. Sodium chloride is a necessary nutritional component required in the amount of about 1,000 mg/day. However, high sodium intake favors the body's retention of water, which can cause hypertension, a proven risk factor in the development of heart disease, heart failure, strokes, and kidney disease. It has been recently recognized that a reduced level of sodium in foods could lead to a significant reduction in the rates of stroke and heart disease.

Many national and international organizations have published advisory guidelines for salt intake. Dietary Guidelines for Americans, jointly published in 2005 by the US Department of Health and Human Services (HHS) and the Department of Agriculture (USDA) state that “on average, the higher an individual's salt (sodium chloride) intake, the higher an individual's blood pressure. Nearly all Americans consume substantially more salt than they need”. The key recommendations include a recommendation to consume less than 2,300 mg of sodium per day (equivalent to about one teaspoon or 5.75 g of salt) and an advice to consume potassium-rich foods including fruits and vegetables. For some specific population groups including individuals with hypertension, individuals of African origin and middle-aged or older adults the Guidelines recommend consumption of less than 1,500 mg of sodium per day (3.75 g of salt) and a minimum daily potassium intake of 4,700 mg. The best source of potassium is fruits and vegetables, which are rich in potassium in its acidic bicarbonate form.

The European Food Safety Authority (EFSA) estimates that the average individual daily intake of sodium in Europe is 3-5 g (8-11 g salt) while only 1 g of salt per day is required to maintain nutritional balance. The UK Food Standards Agency set a target of bringing down the average UK salt intake to 6 g a day, acknowledging that too much salt is a significant risk factor in developing high blood pressure. According to the UK Food Standards Agency, high blood pressure can triple the risk of heart disease and stroke. The World Health Organization (WHO/FAO, 2005) recommends 5 g of salt as the daily intake limit. The Department of Health Canada also recommends reducing sodium intake.

There is a significant need to reduce dietary sodium intake much of which (up to 75%) comes with processed foods manufactured by the food industry and the related food service sector. There is also a need to balance sodium intake with an increased level of potassium.

There have been numerous attempts to address the issue by substituting sodium with potassium or other food salts or acids. Compositions that are used to replace or substitute for sodium chloride are known as salt replacing compositions or sodium chloride replacing compositions. Some of the compositions may include sodium chloride as a part of the balanced formula. In this case the compositions can be considered as partial salt replacing compositions or reduced sodium compositions imparting salty taste. Earlier patents including U.S. Pat. Nos. 1,874,055 and 1,772,183 replaced sodium with acids and acidic salts in various combinations with some success. However, unbalanced sour or chalky notes precluded significant use of such salt substituting compositions.

Other patents have focused on potassium chloride (KCl) as a major component in salt substituting compositions. Depending on concentration and application level, KCl imparts a sour salty sensory perception with very significant metallic and bitter off-notes. Masking of these unacceptable off-notes has become a major challenge and has been attempted with a number of food ingredients, including various salts, organic acids, salts of the organic acids, sweeteners, hydrolyzed vegetable proteins, autolyzed yeasts, amino acids and their salts, most recently salts of nucleic acids. In an overview of the prior art the primarily focus are those patents describing compositions related to the area of compositions of this patent.

U.S. Pat. No. 2,829,056 to Kemmerer describes a dietary seasoning composition that can be used as a salt replacer and comprising by weight about 5.7-17% of a member of the class consisting of a lysine dihydrochloride, a histidine dihydrochloride, and an ornitine dihydrochloride; about 13.6-40.7% of monopotassium glutamate (MPG) or monoammonium glutamate (MAG); and 76.7-38.3% potassium chloride (KCl). Example 1 of the patent shows a preferred composition comprising, by weight, 14.1% lysine dihydrochloride, 33.9% MPG, 48.0% KCl, and 4.0% tricalcium phosphate.

U.S. Pat. No. 4,216,244 to Allen describes a low sodium salt seasoning. Two compositions are described in particular: A) 92.4% KCl, 3% L-glutamic acid, 1% monopotassium glutamate (MPG), 1.3% potassium citrate, 1.3% potassium phosphate, 1% anticaking agent; and B) 90.5% formula 1) plus 9.5% lactose. The composition A) significantly masks metallic notes. However, it also has a sour bite, unbalanced acidity, meaty mid- and after-taste. Composition B), while mitigating some metallic, sour and meaty notes, deviates from salty in overall character and imparts lower salt intensity compared to composition A.

U.S. Pat. No. 4,243,691 to Mohlenkamp et al. describes a composition containing 33.3% potassium chloride, 26.5% dipotassium orthophosphate, 25.8% hydrolyzed vegetable protein (HVP), 10.5% glucose, 2% 5′-guanosinic acid and 1.9% 5′-inosinic acid. In addition to salty notes the composition has significant umami, some metallic, strong meaty and slight chalky notes.

U.S. Pat. No. 4,340,614 to Pich, et al., describes a stringently sodium-restricted dietetic salt and its preparation. The composition comprises of 60-85% KCl, 10-30% potassium adipate, 2-5% potassium tartrate, 0.5-2% potassium glutamate, 0.5-2% adipic acid, 0.004-0.06% potassium inosinate and/or potassium guanylate. The composition has low salty taste intensity, imparts significant sour and meaty notes that are especially obvious at the low salt intensity.

U.S. Pat. No. 4,931,305 to Karppanen et al. describes a salt substitute composition consisting essentially of magnesium sulfate, potassium chloride, sodium chloride and acidic amino acid or acidic acid salt thereof, with the ratio of the respective ingredients on a molar basis being 3:26:69:1 to 4:21:66:9. The preferred acidic amino acid or acidic acid salt is in the form of acidic salt of an amino acid, most preferred is lysine hydrochloride. Example 1 of the U.S. Pat. No. 4,931,305 shows a table salt preparation containing 12 g magnesium sulfate heptahydrate, 28 g potassium chloride, 58 g sodium chloride, 2 g lysine hydrochloride (100 g total of the components). Example 2 of the U.S. Pat. No. 4,931,305 shows a table salt composition containing 1 g of magnesium carbonate, 2 g magnesium oxide, 25 g potassium chloride, 60 g sodium chloride, 10 g tartaric acid, and 2 g lysine hydrochloride. The compositions show some soapy, chalky notes in the aftertaste and reduced salty taste intensity.

U.S. Pat. No. 5,173,323 to Omari describes a process to remove bitterness from KCl by adding non-specified amount of a food acid selected from the group consisting of malic, fumaric, adipic, succinic, hydrochloric or phosphoric acid, and neutralization with potassium hydroxide. Then 2 g of a compound from the group consisting of the amino acids and their salts are added to 100 g potassium chloride in the solution and the solution is dried. The preferred amino acid is L-lysine monohydrochloride. The neutralization step converts the acids into their respective salts, however, the final composition is not clearly defined.

U.S. Pat. No. 5,229,161 to Turk describes a metal free and low metal salt substitutes containing lysine. The substitutes contain two lysine molecules per molecule of succinic acid as a base unit where hydrogen ions can also be substituted for sodium and potassium. Chloride ions can be also associated with the positively charged ammonium groups of lysine at some specific ratios. In the description section and the examples of the patent it is indicated that sodium and potassium can come from sodium chloride, disodium succinate, sodium or potassium hydroxide. The source of chloride ions is lysine monohydrochloride and hydrochloric acid. Numerous preferred molar ratios of the ions are disclosed. Iodine and other minerals can be added to the salt substitutes.

U.S. Pat. No. 5,897,908 to Berglund et al. discloses an edible composition having a salty taste which consists essentially of lysine monohydrochloride, potassium chloride and succinic acid, wherein the weight ratio of lysine monohydrochloride to potassium chloride is between about 1 to 9 and 3 to 2, the weight ratio of lysine monohydrochloride to succinic acid is between about 3 to 1 and 13 to 1, and the composition has a pH between about 5.5 and 6.3.

EP 0125021 B1 to Kiyoshi et al. describes a seasoning composition containing 100 parts KCl, 1.5-30 parts of calcium salt of organic acid (e.g., calcium lactate), 1-30 parts of a salt of glutamic acid salt (e.g., monosodium glutamate (MSG)), or/and 0.01-5 parts of nucleotides (e.g., salts of 5′-inosinate and/or 5′-guanylate). The composition imparts relatively low salt intensity, very significant meaty and slight bitter/metallic notes.

EP 0124254 B1 to Arciszewski at al. describes a salt substitute composition. The composition contains 70-98% KCl, 1-20% non-reducing sugar, preferably sucrose, 0.15-5% anticaking agent (tricalcium phosphate), 0.3-15% organic acid, preferably adipic, and 0.5-10% glutamate salt, preferably potassium glutamate. The composition has some unbalanced sour, chalky and metallic/meaty notes.

U.S. Pat. No. 5,562,943 to Koh et al. describes a salt composition consisting essentially of 100 parts by weight of a mixture consisting of 30 to 75 weight % of sodium chloride and 25 to 70 weight % of sylvinite and 5 to 60 parts by weight of at least one citrate, and wherein the sodium/potassium ion ratio is less than 1. Sylvinite contains about 17% NaCl, 75% KCl, and other minor mineral salts. The composition can additionally include natural seasonings (“for example, natural bases for soup stock, dried bonito, dried small sardines, tangle, mushrooms, meat extracts, etc.”), amino-acid based seasonings (“for example, monosodium L-glutamate, etc.”), nucleic-acid based seasonings (“for example, sodium 5′-guanylate, sodium 5′-inosinate, etc.”) and citrate based seasonings. No specific range of the seasonings or individual components of the seasonings is shown in the claims or in the examples.

International Patent Application WO2006/013997 A1 to Kuroda et al. describes a seasoning composition, seasoning material and process for producing food therewith. The patent discloses the following composition: 100 parts KCl, 1.5-70 parts histidine or salts thereof, 4-100 parts lysine or salts, 2-100 parts of IMP and/or GMP (sodium inosinate and/or sodium guanylate), 20-130 parts of lactic acid or salts, and 5-50 parts of phosphoric acid or salts thereof. The composition has unbalanced meaty and acidic character with some chalky aftertaste.

International Patent Application WO2007/045566 to Ley et al. describes a mixtures having a salty taste and comprising or consisting of: (a) 1 to 50 wt. % of one or more inorganic salts which are suitable for nutrition and are not sodium chloride, (b) 10 to 90 wt. % of one or more mono- or polyvalent salts of polybasic food acids, (c) 0.1 to 30 wt. % of one or more amino acids, or salts thereof, which are suitable for nutrition, (d) 0 to 20% wt. % of sodium chloride.

International Patent Application PCT/US2007/070607 to Zasypkin et al. describes a sodium chloride replacing composition comprising based on 100% total weight: 75-95% of potassium chloride, 3-15% ammonium chloride, 1-15% sucrose, 0.4-5% of disodium inosinate, disodium guanylate or a mixture thereof, 0.1-5% of a low molecular weight organic acid, a mixture of organic acids or their salts other than salts of glutamic acid, and 0.05-0.9% of a salt of glutamic acid or mixtures of such salts. The salt replacing composition can further comprise up to 0.5% of at least one of a taste enhancing and a masking agent selected from the group consisting of a flavor, a flavor adjuvant, a flavor enhancer, and emulsifier and mixtures thereof.

Evaluations of commercially available and above described patented salt replacing compositions in solutions and topically on cucumber and/or tomato slices showed unacceptable metallic, bitter or chalky off-notes. Some compositions may have been able to substantially cover metallic and chalky off-notes, however otherwise remained unbalanced in terms of sour, meaty or other savory notes. Other compositions are relatively balanced but exhibit low intensity or uncharacteristic salty character. Some of the compositions may work well at some levels of sodium reduction in some applications but would not provide a match to full salt controls by salty taste intensity, character, or overall taste in some other applications or at more aggressive levels of sodium reduction. In addition, some of the components of the previously described compositions may not be acceptable in some applications for the reasons of regulatory restrictions and/or customer preferences, limited stability during processing of food or potential interactions with other food ingredients. Most importantly, sodium reduction is a part of a healthier diet. Natural and organic ingredients are the best fit for the healthy reduced sodium foods. Therefore, there is a need for improved salt replacing compositions having desirable taste characteristics, suitable ingredient properties in the specific foods, and comprised of natural and nutritionally beneficial ingredients.

### SUMMARY OF THE INVENTION

Accordingly, it is one object of the present invention to provide a reduced sodium salty taste composition.

It is another object of the present invention to provide a reduced sodium salty taste composition comprising of natural and nutritionally beneficial ingredients.

It is another object of the invention to provide a reduced sodium salty taste composition that significantly reduces or completely eliminates metallic/bitter notes of potassium chloride, enhances salty character and increases the intensity of the true salty taste while keeping the overall taste of foods balanced.

It is another object of the invention to provide a reduced sodium salty taste composition that may be efficiently used as a partial replacer of sodium chloride/table salt for topical and/or ingredient mix applications.

It is another object of the invention to provide condiments and intermediate food preparations such as dough, minced meat, cheese curd, coatings and other food products containing a reduced sodium salty taste composition.

It is another object of the invention to provide a reduced sodium salty taste composition that reduces sodium, increases potassium level, supplements with essential amino acids, and contributes calcium, magnesium and other microelements to foods.

It is another object of the invention to provide a reduced sodium salty taste seasoning composition having a decreased amount of sodium and an increased amount of potassium in comparison to sodium chloride.

It is another object of the present invention to provide a process for preparing a reduced sodium salty taste composition, which controls the degree of mixing of the components, structure and size of particles of the salt replacing composition.

It is another object of the invention to provide a process for controlling the impact of salty taste, enhancing the masking of undesirable off-notes and/or improving salty character in seasonings.

It is another object of the present invention to provide foods, which include a reduced sodium salty taste composition and have a good, intense and balanced salty taste and reduced sodium and increased potassium content.

These objects, as it will become apparent in the following detailed description, have been achieved by the inventor's discovery that certain partial salt replacing compositions not comprising any potassium chloride allow sodium reduction in foods in the range from 10% to 30% by weight of the original level of sodium without compromising salty taste intensity and character. The inventor also discovered that at more aggressive levels of sodium reduction, e.g., such as in the range from 20% to 75% by weight of the original level of sodium in foods, compositions comprising potassium chloride can be used while the metallic/bitter off-notes of potassium chloride can be efficiently masked, the salty character enhanced, and the salty taste intensity increased. The inventor discovered that a synergistic sensory interaction of sodium chloride, potassium chloride, food acids, and some amino acids in pure form not only masked bitter/metallic notes of potassium chloride but also enhanced true salty character and increased salt intensity. Yeast extracts, non-reducing sweeteners, and nucleotides can additionally enhance salty taste and mitigate undesirable notes in the reduced sodium compositions. All the effects have been achieved at significantly lower levels of components other than sodium and potassium chloride compared to many existing salt replacing compositions. It was further discovered that additional components including some types of emulsifiers and flavors may additionally help to balance the composition. True balanced salty character was found to dominate in a wide range of application levels of the reduced sodium salty taste composition of the invention.

### DETAILED DESCRIPTION OF THE PREFERRED EMBODIMENTS

In one embodiment, the present invention provides a reduced sodium salty taste composition which can significantly reduce the amount of sodium chloride in food, seasonings or flavorings and provide a good salty taste to food.

In embodiments, the reduced sodium salty taste composition of the invention comprises:
(i) 1 to 95%, preferably 30 to 90% by weight of sodium chloride,
(ii) 0 to 90%, preferably 10 to 60% by weight of potassium chloride,
(iii) 0.1 to 4.5% by weight of at least one food acid or its salt selected from citric, lactic, malic acids and their salts excluding potassium malate and potassium citrate, wherein the ratio of the total amount of lactic acid and salts of lactic acid to potassium chloride is below 0.2, when the composition contains lactic acid and/or salts of lactic acid and potassium chloride,
(iv) 0.1 to 8%, preferably 0.3 to 5% by weight of at least one amino acid or a salt of an amino acid, wherein the amino acid is at least one selected from the group of lysine, arginine, aspartic acid, histidine and their salts, and glutamic acid,
(v) up to 10%, preferably 0.1 to 5% by weight of a yeast extract,
(vi) up to 10%, preferably 0.1 to 5% by weight of a natural flavor selected from natural extracts and Maillard reaction flavors.
(vii) up to 10%, preferably 0.1 to 5% by weight of at least one sweetener selected from the group consisting of sucrose, trehalose, lactitol, erythritol, maltitol, sorbitol, mannitol, xylitol, and a hydrogenated starch hydrolyzate,
(viii) up to 5% by weight of at least one of a taste enhancing agent and a masking agent, wherein the taste enhancing agent and the masking agent are selected from the group consisting of a flavor, a flavor adjuvant, a flavor enhancer, an emulsifier and mixtures thereof, and
(ix) up to 5%, preferably, 0.1-2% by weight of at least one of 5′-guanine monophosphate, 5′-inosine monophosphate and their salts,
wherein % by weight is based upon the total weight of (i), (ii), (iii), (iv), (v), (vi), (vii), (viii), and (ix).

The reduced sodium compositions impart intense and balanced salty character in solutions and in many foods including topically on vegetables, in seasonings applied to chips, coatings applied to fried meats, in soups and gravies, in mashed green beans, crackers, and other food applications.

A most preferred reduced sodium composition of the invention provides a more intense salty taste and better balanced sensory attributes similar to those of table salt versions of the foods when compared to other naturally occurring, patented, or conventional compositions at the same level of salt or sodium reduction in foods.

The reduced sodium composition of the present invention may exist as a powder, granular blend, or a liquid, and may occur as one component of a mixture of components such as a final food or intermediate food prepared with this salt replacing composition. One preferred form of the reduced sodium composition is a homogeneous powder constituted of particles with the size in the range from one micrometer to about three millimeters. The particles can have various shapes and physical structure from pure crystalline to completely amorphous and/or glassy. The shape and physical structure in some cases are determined by the processes involved in the preparation of original constituents while in other cases result from additional processing of the primary components, as described in this section. The particles in the identified size range may have an internal structure of clusters or aggregates of smaller particles. The presence of free particles with a size under one micrometer will typically cause segregation, dusting, electrostatic attraction in processing, and therefore is not preferred in this invention.

Sodium chloride is one of the components of the reduced sodium composition. It is added to achieve synergistic salty taste enhancement in the presence of other components, mask possible off-notes of other components, and prevent other components from segregation, caking or undesirable interactions in the dry blends or solutions. Sodium chloride can be in any liquid or solid crystalline form originating from mineral or rock salt, sea salts including reduced sodium sea salt additionally containing potassium chloride and other salts, and other significant sources of sodium chloride. Sodium chloride can be used in various crystalline or partially amorphous shapes known in the industry: from large coarse random crystals to granulated, flaked, or micronized salt.

Potassium chloride may be a major component of the reduced sodium composition of the invention. It provides salty and sour attributes to the composition, the balance of which depends on potassium chloride concentration. It also comes with known metallic/bitter off-notes which are highly undesirable and have to be mitigated. Potassium chloride is also a source of potassium ions that are recommended in a diet to counterbalance sodium.

Potassium chloride may not be necessary in some reduced sodium compositions targeting 10 to 30% sodium reduction but in embodiments may be a major component of compositions targeting sodium reduction levels above 20%. As a major component of these reduced sodium compositions, potassium chloride may be the single component that is present in the highest amount when calculated based on the weight of the potassium chloride relative to the weight of the total composition. Preferably, the potassium chloride is present in an amount of at least 20 wt %, more preferably potassium chloride is present in an amount of at least 30 wt %, even more preferably 40 wt %. In other embodiments, potassium chloride is present in an amount of 50 wt %, 60 wt %, 70%, 80% or 90%. When percent by weight (wt %) is calculated, the amount of inert, non-flavoring or non-active components is not included in the total weight of the composition.

The potassium chloride can be in any physical form including powder, granule, liquid solution, dispersion or slurry. Food grade materials rich in potassium chloride can also be used as a source of potassium chloride. The source can be from purified mineral deposits as well as from sea water bittern as an example. Another source can be reduced sodium sea salts enriched in potassium chloride and containing both sodium chloride and potassium chloride as major components and other mineral salts as minor constituents. Sylvinite being the concentrated mother liquor after extraction of sodium chloride from sea water and containing typically by weight 17% sodium chloride, 75% potassium chloride, 0.4% calcium chloride, 0.8% calcium sulfate, 0.9% magnesium chloride, some moisture and other trace minerals can be another source of potassium chloride in the composition. One preferred form of potassium chloride is its pure crystalline form that may include up to 2%, preferably, less than 1% by weight of sodium chloride and other impurities. Potassium chloride is also available in a pure form containing less than 50 ppm of sodium in the form of sodium chloride. Another preferred source of potassium chloride is reduced sodium sea salt comprising 40% to 60% by weight of potassium chloride.

Organic acids may include any of citric, lactic, and malic acids. Their acidic salts include sodium, potassium, and calcium salts and their hydrate crystal forms with the exception of potassium malate and potassium citrate excluded from the claims. In other embodiments one or more other organic acids and/or salts thereof may be further excluded. Organic acids or their salts can be in a powder, granular, or liquid form. Hydrate crystal forms of organic acids or their salts can be used. Organic acids or their salts can also be used individually or in a combination. Organic acids can be protected by a coating or encapsulated to prevent caking and reaction with other components.

There are many types of amino acids and, in fact, about 500 kinds of amino acids have been discovered in nature. However, only 20 amino acids serve as the constituents of food proteins and our body. Various combinations of these 20 amino acids produce as many as 100 thousand various proteins. Proteins contained in food are first degraded to the 20 amino acids, and then reassembled into proteins in the body. The 20 amino acids include valine, leucine, isoleucine, alanine, arginine, glutamine, lysine, aspartic acid, glutamate, proline, cysteine, threonine, methionine, histidine, phenylalanine, tyrosine, tryptophan, asparagine, glycine, and serine. The following nine amino acids are essential and are not synthesized in the body: valine, leucine, isoleucine, lysine, threonine, methionine, histidine, phenylalanine, and tryptophan.

The most preferred amino acids of the present invention are lysine, arginine, glutamic acid and the salts of the aforementioned amino acids except the sodium and potassium salts of glutamic acid known as, respectively, sodium and potassium glutamates. The most preferred salts of lysine and arginine are lysine hydrochloride, lysine dihydrochloride and arginine hydrochloride, respectively. Amino acids and their salts may include water in their crystalline structure forming hydrate crystals. Naturally, amino acids are mainly present in their left-hand stereo isomeric form simple denoted as L-form, for example, L-arginine. However, a small fraction of a right-hand form denoted as D-form is typically present. A mixed composition of the forms can be prepared. In this invention, most common L-form of the amino acids is preferably used.

Amino acids are commercially produced via two major pathways: fermentation and protein hydrolysis. Currently, the amino acids are mainly manufactured by a fermentation method. In this method some selected strains of microorganisms convert natural raw materials such as syrups and sugars in a culture media into amino acids. A fermentation tank is filled with syrups/sugars derived from sugar cane, corn, and cassaya, and then fermentation conditions are set so that the stirring conditions, air supply, temperature, and pH are optimum. Consecutive reactions by 10 to 30 types of enzymes are involved in the process of fermentation, and various amino acids are produced as a result of these reactions. Finally, the target amino acids are produced from this fermented broth in high purity.

According to a manufacturer's specification (Ajinomoto USA, Inc.) the purified amino acids contain not less than 98.5% and not more than 101% of a pure amino acid, 0.5% moisture, 0.1% ash. Total impurities including other amino acids are determined chromatographically. The number of impurity peaks does not exceed four and total impurities do not exceed 2% by weight of the amino acid.

Amino acids in the presence of moisture could react with reducing sugars, forming the products of Maillard reaction. The reaction is significantly accelerated at elevated temperatures, at pH close to neutral, and intermediate moisture (15-30% water by weight) in a composition. Amino acids can be optionally protected by a coating or other encapsulating agent to prevent caking and reaction with other components. When the reduced sodium composition contains sweeteners these sweeteners are selected from non-reducing sugars, polyols or high intensity sweeteners to prevent chemical interaction of the sweeteners with amino acids in the composition.

Yeast extract is used in the reduced sodium salty composition in any of the following forms: autolytic or hydrolytic yeast extract. Depending on the original composition of yeast the extracted hydrolyzate can be rich in amino acids and nucleotides. These components of yeast can mask undesirable notes of other components in the composition and/or synergistically enhance salty taste intensity and balance overall taste. Depending on the medium the yeast are grown at some additional flavor notes can be brought in with the hydrolyzed yeast extract. The most preferred in this invention is the high nucleotide yeast having slight to moderate meaty or bouillon-like notes. The high nucleotide yeast extract may contain between 10% to 20% by weight of such nucleotides as 5′-guanine monophosphate, 5′-inosine monophosphate and their salts.

Sweeteners include any non-reducing sugars, e.g., sucrose and trehalose, and any sugar alcohols (polyols) including mannitol, maltitol, erythritol, xylitol, sorbitol, lactitol, palatinol, and hydrogenated starch hydrolyzates. High intensity sweeteners including aspartame, potassium acesulfame, cyclamate, saccharin, sucralose, neotame, Stevia extract and others can be used in a concentrated or a diluted form as a sweetener. The sweetener in the salt replacing composition can be a combination of the sweeteners listed above. The sweeteners present in the reduced sodium salty taste composition may function to balance the taste, somewhat masking bitterness and excessive sour taste, and enhancing salty character. The sweeteners can be in any form including powder, granulated powder, encapsulated or agglomerated with other sweeteners or components of the composition.

A flavor can be added to the salt replacing composition to enhance the salty character of the composition in a specific food application; help to balance the overall flavor and/or to additionally mask some undesirable notes resulted from sensorial interaction of ingredients in the food. The term flavor includes spice oleoresins and oils derived from any of allspice, basil, capsicum, cinnamon, cloves, cumin, dill, garlic, marjoram, nutmeg, paprika, black pepper, rosemary and turmeric; essential oils including anise oil, caraway oil, clove oil, eucalyptus oil, fennel oil, garlic oil, ginger oil, peppermint oil, onion oil, pepper oil, rosemary oil, and spearmint oil; citrus oils such as orange oil, lemon oil, bitter orange oil and tangerine oil; alliaceous flavors including garlic, leek, chive, and onion; botanical extracts including arnica flower extract, chamomile flower extract, hops extract, and marigold extract; botanical flavor extracts including blackberry, chicory root, cocoa, coffee, kola, licorice root, rose hips, sassaparilla root, sassafras bark, tamarind, licorice, and vanilla extracts; protein hydrolysates including hydrolyzed vegetable protein (HVPs), meat protein hydrolysates, milk protein hydrolysates; compounded flavors both natural and artificial including those disclosed in S. Heath, Source Book of Flavors, Avi Publishing Co. Westport, Conn., pp. 149-277, 1981, which is incorporated herein by reference in its entirety; and processed (reaction) flavors prepared through a Maillard type reaction between reducing sugars and protein derived components including amino acids. Representative individual flavor compounds include benzaldehyde, diacetyl (2,2-butanedione), vanillin, ethyl vanillin and citral (3,7-dimethyl-2,6-octadienal).

A flavor adjuvant or flavor enhancer can be optionally added to the composition to further enhance the salty character of the composition in a specific food application, help to balance the overall flavor or additionally mask some undesirable notes resulted from sensorial interaction of ingredients in the food. Flavor adjuvants or flavor enhancers can include various classes of food additives including organic acids, fatty acids, salts of organic acids, and emulsifiers. Potassium iodide may be added to provide a micronutrient that is necessary in the diet.

An emulsifier can be optionally added or combined with other components to further improve salty character of the composition in some applications. Emulsifiers include distilled monoglycerides, ethoxylated monoglycerides, lactylated monoglycerides, acetylated monoglycerides, diacetyl tartaric acid esters of monoglycerides (D.A.T.E.M.'s), propylene glycol monoesters, sorbitan monostearate, sorbitan tristearate, polyglycerol esters of fatty acids, sorbitan polyoxyethylene monoester and triesters, sucrose esters, sodium stearoyl lactylate, lecithin, hydroxylated lecithin, oleyl lactylic acid, lactylated esters of monoglycerides, lactylated esters of propylene glycol and monoglycerides, sodium lauryl sulfate, cetyl pyridinium salt, and the sodium and potassium salts of fatty acids singly or in combination. The emulsifier(s) may be preferably present in an amount of up to 0.5% in the salt replacing composition.

5′-guanine monophosphate, 5′-inosine monophosphate can be used individually or in a combination. These components of the reduced sodium composition may also present as their salts known as disodium inosinate or disodium guanylate, also known as inosine 5′-monophosphate disodium salt or guanosine 5′-monophosphate disodium salt hydrate, respectively. Alternatively, the ingredients can be named 5′-inosinic acid disodium salt hydrate or 5′-guanylic acid disodium salt hydrate, respectively. Potassium or ammonium salts of the inosinic or guanosinic acids may be used in a salt replacing composition.

Both disodium inosinate and disodium guanylate could work synergistically with amino acids and their salts to enhance the salty character of sodium and potassium chloride while masking bitter/metallic off-notes of potassium chloride in the reduced sodium composition of the invention. Hydrate crystal forms of disodium inosinate and disodium guanylate can be used.

A flow agent can be optionally added to the reduced sodium composition or any component of the reduced sodium composition and selected, for example, from silicon dioxide, fumed silica, sodium alumino silicate, basic magnesium carbonate, tricalcium phosphate, magnesium oxide, calcium silicate, powdered and crystalline cellulose, sodium ferrocyanide decahydrate, and starch.

When used as a dry blend, the reduced sodium composition may have components with comparable particle sizes to avoid segregation of the components. The components in some cases may be ground, milled, sieved or otherwise processed to bring the particles or fractions to the desired size tailored to an application for the desired kinetics of taste and aroma impact. Typically, particles in the preferred composition will have sizes in the range from one micrometer to three millimeters. In some cases, these particles may constitute aggregates of submicron size particles brought together to form a larger aggregate. Having submicron particles in a free form can cause significant dusting, segregation, and electrostatic adherence problems. The reduced sodium composition to be used as a table salt or in a seasoning preferably will have particles in the range from 20 to 60 mesh of US Standard sieve size. However, some other applications may require significantly larger particles in the range from 0.5 to 3 mm.

The invention also provides a process for preparing the reduced sodium salty taste composition. The reduced sodium compositions can be prepared by straight blending of the components. In addition, whenever smaller particles are desired, the components can be co-milled, dissolved or dispersed and dried, for example, spray-dried, ball milled or otherwise reduced by any of the available techniques. If larger particles are desired, an agglomeration, compaction and/or a coating process including, for example, fluidized bed coating, roll compaction or an extrusion process combined with drying and milling may be used.

In a further embodiment, the invention provides a food or a food intermediate having reduced sodium chloride/sodium content and an intense balanced salty taste, and containing the reduced sodium composition of the invention.

Examples of foods which may include the present reduced sodium composition include any food to which sodium chloride is added to enhance the salty taste and/or the flavor in general. Such foods include but are not limited to seasonings, soups, snacks, and foods with a coating, condiments (including sauces, rubs, marinades, dressings, salsas, and the like), meats, vegetables, fruits, cereals, processed foods, flavored seasonings, ingredient blends and flavorings.

Other details and features of the compositions described in the present invention will be more apparent from the exemplary embodiments, which are provided for illustration of the invention and are not intended to be limiting thereof.

### EXAMPLES

The following examples further illustrate the preferred embodiments and functionality of the reduced sodium and seasoning compositions.

### Example 1

100 g of dry powder components made up by weight of 92.82% of sodium chloride, 1.82% of arginine, 0.93% lysine monohydrochloride, 1.11% of anhydrous citric acid, 1.99% lactic acid, and 1.33% calcium lactate were mechanically blended and shaken in a closed container to form a reduced sodium composition containing 7.18% less sodium chloride than 100 g of pure sodium chloride.

The reduced sodium composition was tested topically on plain potato chips. The chips containing no seasoning were warmed up in a bag in a microwave oven and seasoned with sodium chloride in the form of granular salt used as a control, or with the reduced sodium composition of this example. Sodium content was reduced from 180 mg of sodium per serving in the full salt control chips down to 126 mg of sodium per serving in the experimental chips targeting 30% sodium reduction. Additional control was prepared by simple reduction of sodium down to 126 mg per serving. A panel of four trained descriptive panelists evaluated the chips, using a degree of difference scale from 1 to 3 where 3 were assigned to full salt control. The control containing 30% less sodium scored 2.2. The sample scored 2.6 with mainly positive comments and can be considered acceptable though may not be a perfect match to the full salt control.

### Example 2

A series of related reduced sodium compositions disclosed in Table 1 were tested in a number of model foods. In the first model: commercially available cooked pureed green beans not containing any sodium according to the nutritional label, the reduced sodium compositions were used internally at 0.5% by weight of beans and compared to full salt control beans containing 0.5% table salt. A panel of nine trained descriptive panelists evaluated the green beans, using a degree of difference scale from 1 to 10, where 9-10 was a match to the full salt control. Compositions A, C, and D scored higher than full salt control tested in blind at, respectively, 22.6%, 33.7%, and 34.1% by weight of sodium reduction in beans (Table 1).

In the second model: commercially available chicken broth containing no salt, the reduced sodium compositions were tested in the same way as in green beans and at the same levels of sodium reduction (Table 1). The highest score of 7.6 was reached with the compositions A and C at 22.6 and 33.7% sodium reduction, respectively, while blind control scored 8.3.

The reduced sodium compositions were tested topically in the third model: plain potato chips. The chips containing no seasoning were warmed up in a bag in a microwave oven and seasoned with sodium chloride in the form of granular salt used as a control, or with the reduced sodium compositions. Sodium content was reduced from 180 mg of sodium per serving in the full salt control chips down to 126 mg of sodium per serving in the experimental chips targeting 30% sodium reduction. Additional control was prepared by simple reduction of sodium down to 126 mg per serving. A panel of seven trained descriptive panelists evaluated the chips, using a degree of difference scale from 1 to 3 where 3 was assigned to full salt control. The control containing 30% less sodium scored 2.1 (Table 1). The best score of 2.6 was reached using the reduced sodium composition D. Such score could be considered acceptable though may not be a perfect match to the full salt control.

TABLE 1

| | CONTROL | A | B | C | D |
|---|---|---|---|---|---|
| NaCl | 100 | 77.349 | 76.782 | 66.299 | 65.882 |
| KCl | | 16.668 | 16.546 | 28.572 | 28.393 |
| Arginine | | 1.518 | 1.507 | 1.301 | 1.293 |
| Lysine*HCl | | 0.774 | 0.768 | 0.664 | 0.659 |
| Citric acid | | 0.923 | 1.100 | 0.791 | 0.944 |
| Lactic acid | | 1.661 | 1.978 | 1.424 | 1.697 |
| Calcium lactate | | 1.107 | 1.319 | 0.949 | 1.132 |

GREEN BEANS: sensory scale from 0 to 10, eight panelists

| | | | | | |
|---|---|---|---|---|---|
| Na | 0 | 22.60% | 23.20% | 33.70% | 34.10% |
| REDUCTION | | | | | |
| Sensory score | Blind control | 8.3 | 7.8 | 8.4 | 8.3 |
| | 8.1 | | | | |
| COMMENTS | None | More metallic | More sour | None | None |

CHICKEN BROTH: sensory scale from 0 to 10, eight panelists

| | | | | | |
|---|---|---|---|---|---|
| Na | 0 | 22.60% | 23.20% | 33.70% | 34.10% |
| REDUCTION | | | | | |
| Sensoy score | Blind control | 7.6 | 7.1 | 7.6 | 6.4 |
| | 8.3 | | | | |
| COMMENTS | None | More total, | Less total, | None | More bitter |
| | | More metallic | Less chicken | | Less salt |

POTATO CHIPS: sensory scale from 0 to 3.0, seven panelists

| | | | | | |
|---|---|---|---|---|---|
| Na | 30%, no | 30% | 30% | 30% | 30% |
| REDUCTION | replacer | | | | |
| Sensory score | 2.1 | 2.4 | 2.4 | 2.5 | 2.6 |
| COMMENTS | Less salt | Slightly low | Slightly low | Slightly | Slightly |
| | | salt | salt | sour, | sour |
| | | Slightly | Slightly | Astringent | |
| | | earthy | earthy | | |

### Example 3

100 g of dry powder components made up by weight of 54.22% of sodium chloride, 39.82% of potassium chloride, 1.07% of arginine, 0.54% lysine monohydrochloride, 0.78% of anhydrous citric acid, 1.40% of lactic acid, 0.93% of calcium lactate, and 1.24% of yeast extract were mechanically blended and shaken in a closed container to form a reduced sodium composition containing 45.61% less sodium chloride than 100 g of pure sodium chloride.

The reduced sodium composition was tested topically on plain potato chips as described in the Example 1 at 30% sodium reduction. A panel of four trained descriptive panelists evaluated the chips. The panel was repeated twice at different dates one week apart with new samples of the reduced sodium composition and chips prepared each time. The control containing 30% less sodium scored 2.2 and 2.1. The sample scored 2.8 and 2.7 with mostly positive comments. Such scores indicate a match to the full salt control.

The reduced sodium composition was evaluated in chicken broth as described in the Example 2 at two levels of 45.61% and 22.81% by weight of sodium reduction. The composition scored 7.0 and 8.0, respectively, showing a match to full salt control at 22.81% of sodium reduction. The composition has been also tested internally in mashed green beans as described in the Example 2 at the sodium reduction levels as above. The sensory score was 7.3 at both levels thus indicating that the composition was more efficient in chicken broth.

### Example 4

100 g of dry powder components made up by weight of 54.63% of sodium chloride, 40.13% of potassium chloride, 1.06% of arginine, 0.55% of lysine monohydrochloride, 0.78% of anhydrous citric acid, 1.41% of lactic acid, 0.94% of calcium lactate, and 0.50% of yeast extract were mechanically blended and shaken in a closed container to form a reduced sodium composition containing 45.47% less sodium chloride than 100 g of pure sodium chloride.

The reduced sodium composition was tested topically on potato chips and internally in chicken broth and mashed green beans as described in the Example 2 by the descriptive panel at two levels of sodium reduction in all three applications: 45.47% and 22.74% by weight. The composition scored 7.3 at both levels of sodium reduction in chicken broth, 7.4 and 8.2 on potato chips, and 7.3 and 7.9 in mashed green beans, respectively, at the high and low levels of sodium reduction. Such high scores at lower levels of sodium reduction in combination with mostly positive comments from the tests on potato chips and in green beans indicate a close match of the samples to the full salt control.

### Example 5

100 g of dry powder components made up by weight of 78.03% of a combination of natural sea salt and reintroduced natural potassium chloride, containing 57% less sodium than equivalent amount of table salt, 17.12% of sea salt containing 99.97% of sodium chloride, 1.07% of arginine, 0.55% lysine monohydrochloride, 0.78% of anhydrous citric acid, 1.17% of lactic acid, 0.78% of calcium lactate, and 0.50% of a high nucleotide yeast extract were mechanically blended and shaken in a closed container to form a reduced sodium composition containing 50.0% less sodium chloride than 100 g of pure sodium chloride. The 57% less sodium combination of sea salts in addition to sodium chloride and potassium chloride contains 2.84% of magnesium chloride hexahydrate, 0.017% of calcium sulfate and 0.003% of other microelements typical for sea salts.

The reduced sodium composition was tested topically on 4 mm thick English cucumber slices. A slice seasoned with 0.06 g of the reduced sodium composition was compared to a control slice seasoned with 0.04 g of table salt as to salty taste intensity. In this test the sample slice contained 25% less sodium than the control slice. Six experienced panelists participated in the paired sensory test. Five panelists identified the sample seasoned with the reduced sodium composition as having more intense salty taste though some of the comments favored control as to more balanced salty character. This example demonstrates that other sources of potassium chloride such as reduced sodium sea salts can be efficiently used in the reduced sodium composition of this invention.

### Example 6

100 g of dry powder components made up by weight of 88.5% of sodium chloride, 3.53% of arginine, 1.77% of lysine monohydrochloride, 1.55% of anhydrous citric acid, 2.79% of lactic acid, and 1.86% of calcium lactate were mechanically blended and shaken in a closed container to form a reduced sodium composition containing 11.5% less sodium chloride than 100 g of pure sodium chloride.

The reduced sodium composition was mixed uniformly with green beans or applied topically on potato chips as described in the Example 2 and the Example 1 of this invention, respectively, targeting 25% sodium reduction in regards to full salt controls. A panel of eight trained descriptive panelists evaluated the green beans and the chips, using a degree of difference scale from 1 to 10, where 9-10 was a match to the full salt control. The evaluation resulted in 7.4 and 7.6 average score, respectively, for the green beans and the potato chips. Some panelists commented on the samples as being less salty and/or more sour. Such scores can be acceptable though may not be a perfect match to the full salt controls.

1. A reduced sodium composition having salty taste, comprising:
a) 1 to 95% by weight of sodium chloride,
wherein % by weight is based on the total weight of a), b), c) and d) in the composition;
b) 0 to 90% by weight of potassium chloride,
c) 0.1 to 4.5% by weight of at least one food acid selected from citric acid, lactic acid, malic acid and salts thereof,
wherein the food acid is not potassium malate or potassium citrate,
wherein the ratio of the total amount of lactic acid and salts thereof to the total amount of potassium chloride is below 0.2 when lactic acid or a salt of lactic acid, and potassium chloride are present in the composition,
d) 0.1 to 8% by weight of at least one amino acid or a salt thereof selected from the group consisting of lysine, arginine, aspartic acid, histidine, a salt of lysine, a salt of arginine, a salt of aspartic acid, a salt of histidine, and glutamic acid.

2. The reduced sodium composition of claim 1, comprising at least one selected from the group consisting of citric acid, lactic acid, a salt of citric acid, a salt of lactic acid, and hydrate crystals thereof.

3. The reduced sodium composition of claim 1, comprising at least one amino acid or a salt of an amino acid selected from the group consisting of lysine monohydrochloride, lysine dihydrochloride, arginine and arginine hydrochloride.

4. The reduced sodium composition of claim 1, further comprising 0.01% to 10% by weight of a yeast extract.

5. The reduced sodium composition of claim 4 wherein the yeast extract is a high nucleotide yeast extract comprising 10% to 30% by weight of at least one selected from the group consisting of 5′-guanine monophosphate, 5′-inosine monophosphate and salts thereof.

6. The reduced sodium composition of claim 1, further comprising 0.01% to 10% by weight of at least one natural flavor selected from the group consisting of a natural extract and a Maillard reaction flavor.

7. The reduced sodium composition of claim 4, further comprising 0.01% to 10% by weight of at least one natural flavor selected from the group consisting of a natural extract and a Maillard reaction flavor.

8. The reduced sodium composition of claim 1, further comprising 0.1% to 10% by weight of at least one sweetener selected from the group consisting of sucrose, trehalose, lactitol, erythritol, maltitol, sorbitol, mannitol, xylitol, and a hydrogenated starch hydrolyzate.

9. The reduced sodium composition of claim 4, further comprising 0.1% to 10% by weight of at least one sweetener selected from the group consisting of sucrose, trehalose, lactitol, erythritol, maltitol, sorbitol, mannitol, xylitol, and a hydrogenated starch hydrolyzate.

10. The reduced sodium composition of claim 1, further comprising:
0.01% to 5% by weight of at least one selected from the group consisting of a flavor, a flavor adjuvant, a flavor enhancer, an emulsifier and mixtures thereof.

11. The reduced sodium composition of claim 4, further comprising:
0.01% to 5% by weight of at least one selected from the group consisting of a flavor, a flavor adjuvant, a flavor enhancer, an emulsifier and mixtures thereof.

12. The reduced sodium composition of claim 1, further comprising 0.01% to 5% by weight of at least one selected from the group consisting of 5′-guanine monophosphate, 5′-inosine monophosphate and salts thereof.

13. The reduced sodium composition of claim 4, further comprising 0.01% to 5% by weight of at least one selected from the group consisting of 5′-guanine monophosphate, 5′-inosine monophosphate and salts thereof.

14. A table salt comprising the reduced sodium composition of claim 1.

15. A table salt comprising the reduced sodium composition of claim 4.

16. A process for preparing the reduced sodium composition of claim 1, comprising blending of the components and subjecting the composition to at least one of blending, impact milling, ball milling, jet milling, spray drying, fluidized bed coating, agglomerating, and extruding, to form a dry blend.

17. A process for preparing the reduced sodium composition of claim 4, comprising blending of the components and subjecting the composition to at least one of blending, impact milling, ball milling, jet milling, spray drying, fluidized bed coating, agglomerating, and extruding, to form a dry blend.

18. A food containing the reduced sodium composition of claim 1.

19. A food containing the reduced sodium composition of claim 4.
